(19) United States
(12) Patent Application Publication
(10) Pub. No.: US 2017/0124462 A1
(43) Pub. Date: May 4, 2017

(54) COGNITIVE INTENTION DETECTION SYSTEM, METHOD, AND RECORDING MEDIUM FOR INITIATING AUTOMATED WORKFLOW IN MULTIMODAL MESSAGING

(71) Applicant: International Business Machines Corporation, Armonk, NY (US)

(72) Inventors: Pierre Elie Arbajian, Matthews, NC (US); Jeb R. Linton, Manassas, VA (US); James R. Kraemer, Santa Fe, NM (US)

(21) Appl. No.: 14/924,943

(22) Filed: Oct. 28, 2015

(51) Int. Cl. G06N 5/04; G06F 17/27; G06N 99/00; G06F 3/0482

(52) U.S. Cl. CPC G06N 5/04; G06F 3/0482; G06F 17/2785; G06N 99/005; G06F 2203/04804

(57) ABSTRACT

A method, system, and recording medium for cognitive intention detection, including displaying one or more options for automated workflow based on a learned association with a user input, selecting an option of the one or more options for automated workflow, and automating a workflow based on the option selected in the selecting.

### BACKGROUND

The present invention relates generally to cognitively recognizing a user's intention and desired task, and more particularly, but not by way of limitation, to a system, a method, and a recording medium for cognitively recognizing the user's intention and desired task by continuously analyzing an input and presenting the user a list of “desired” functions from a finite list of functions, pre-built templates and workflow tasks to assist the user.

Conventional systems are limited in their cognitive interaction with the message author in that the user must take additional tedious steps and invoke other functions and other tools or applications to perform the desired workflow. The steps required to perform those additional functions differ between systems and environments and the user will generally forego those additional steps such that the user's needs are only partially met.

That is, the above conventional system, and all other conventional cognitive intention detection systems are limited in their application in that they fail to recognize a user's intention through cognitive deduction such that the user is not presented with any additional capabilities and functions integrated within a single environment to offload any workload from the user.

Thus, there is a technical problem in the conventional systems that modem messaging systems are integrating multiple modes (i.e., e-mail, instant message, twitter, etc.) such that the complexity of handling the systems is drastically increasing over time and users are not able to manage all of the messaging or workflow that they need to complete. That is, the conventional systems have a technical problem in that the systems do not attempt to remove any of the workload from a user and the user, is tasked with completing each workflow by themselves and managing all tasks. Accordingly, time to complete tasks is increased, costs to complete tasks is increased, and overall fatigue of a user is increased.

### SUMMARY

In an exemplary embodiment, the present invention can provide a cognitive intention detection method, including displaying one or more options for automated workflow based on a learned association with a user input, selecting an option of the one or more options for automated workflow, and automating a workflow based on the option selected in the selecting.

Further, in another exemplary embodiment, the present invention can provide a cognitive intention detection method, including displaying one or more options for automated workflow based on a learned association with a user input, selecting an option of the one or more options for automated workflow, and automating a workflow based on the option selected in the selecting step.

Even further, in another exemplary embodiment, the present invention can provide a system for cognitive intention detection, including a display device configured to display one or more options for automated workflow based on a learned association with a user input, a selection device configured to select an option of the one or more options for automated workflow, and a workflow automation device configured to automate a workflow based on the option selected by the selection device.

There has thus been outlined, rather broadly, an embodiment of the invention in order that the detailed description thereof herein may be better understood, and in order that the present contribution to the art may be better appreciated. There are, of course, additional exemplary embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as in the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 exemplarily shows a block diagram illustrating a configuration of a cognitive intention detection system 100.

FIG. 2 exemplarily shows a high level flow chart for a cognitive intention detection method 200.

FIG. 3 depicts a cloud computing node according to an embodiment of the present invention.

FIG. 4 depicts a cloud computing environment according to another embodiment of the present invention.

FIG. 5 depicts abstraction model layers according to an embodiment of the present invention.

### DETAILED DESCRIPTION

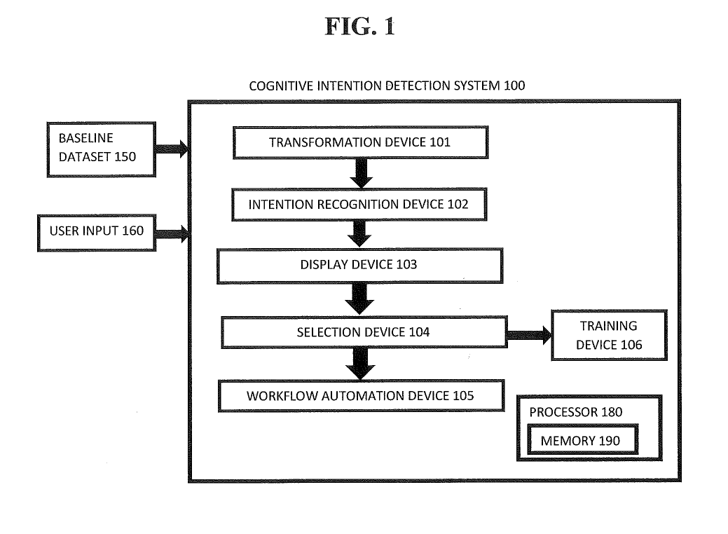

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

With reference now to FIG. 1, the cognitive intention detection system 100 includes a transformation device 101, an intention recognition device 102, a display device 103, a selection device 104, a workflow automation device 105, and a training device 106. The cognitive intention detection system 100 includes a processor 180 and a memory 190, with the memory 190 storing instructions to cause the processor 180 to execute each device of the cognitive intention detection system 100.

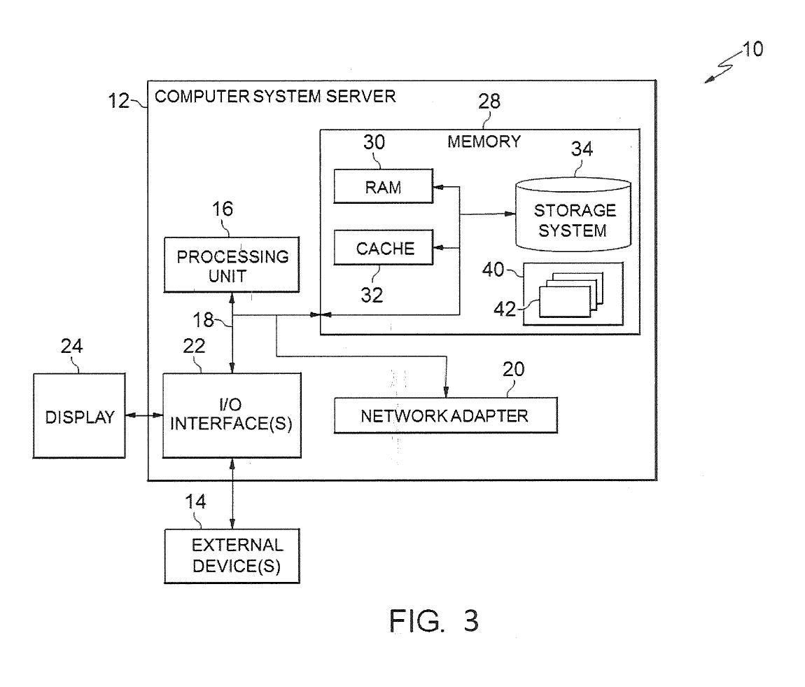

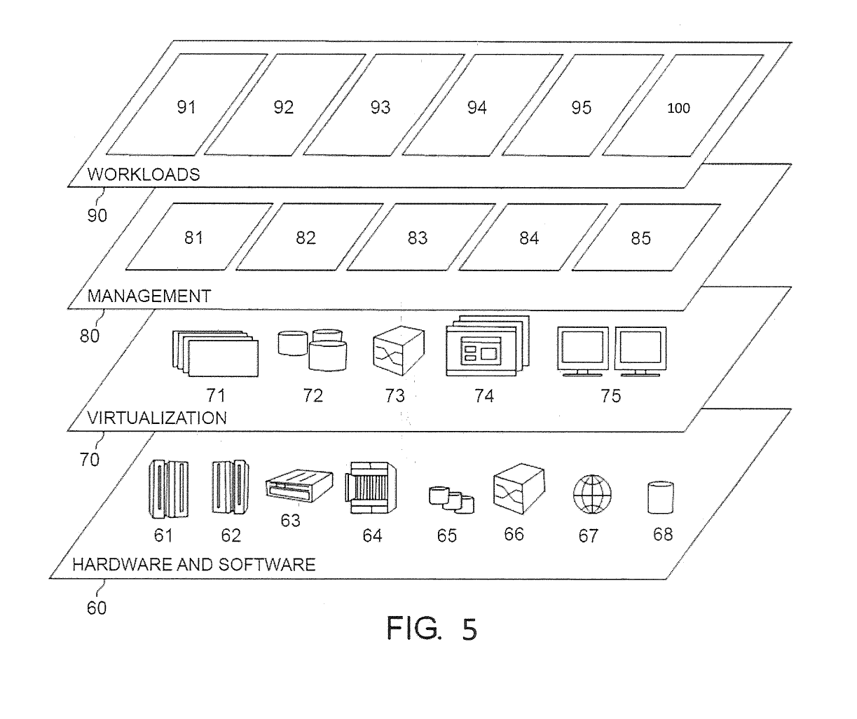

Although as shown in FIGS. 3-5 and as described later, the computer system/server 12 is exemplarily shown in cloud computing node 10 as a general-purpose computing device which may execute in a layer of the cognitive intention detection system 100 (FIG. 5), it is noted that the present invention can be implemented outside of the cloud environment.

The cognitive intention detection system 100 initially receives a baseline dataset 150. The baseline dataset 150 includes a machine learning implementation that is performed once to create a baseline of workflows and workflow methods for the system to perform.

It should be noted that a workflow described herein can include, but is not limited to, (1) a graphic workflow including inserting a map, inserting a calendar, inserting photos, inserting emoticons and symbols, inserting videos, and inserting graphics; (2) a formatting workflow including inserting tables, translating to latex, inserting and formatting formal legal documents, inserting accounting documents such as invoice statement, inserting a Power Point®, inserting a chart, inserting pictures, and inserting a pdf version of the message; (3) an information tracking workflow including tracking votes, volunteering sign-up, managing a list of tasks, vote taking, and monitoring RSVPs to the votes; (4) a translation workflow including translating text language, translating time zones, converting currencies, displaying time to various formats, and displaying time in various time zones; (5) a Workflow/Activity tracking including reminders, To-dos, availability, project management, and sending a task sign up list; (6) an informational attachment workflow including inserting contact information, inserting dictionary/Wikipedia® definitions, synonyms, inserting URLs with description, and inserting a recording; and (7) a support function workflow including a calculator; a Web search; spreadsheet calculations; action reminders; and providing calculator functions. The workflows listed herein are exemplary and non-limiting, and future workflows or any type of workflow can be automated by the cognitive intention detection system 100 and tailored by the invention.

The baseline dataset 150 is trained using a lexicon of words derived through Concept Expansion using a co-occurrence of workflow related terms with high Inverse Document Frequency (IDF) in documentation related to the messaging system.

It should be noted that the baseline dataset 130 to be input into the cognitive intention detection system 100 is created by an external source (i.e., a team of people) and pre-programmed or input into the cognitive intention detection system 100 prior to a first time that the cognitive detection system 100 is operated by a user.

More specifically, a list of available functions are categorized into multiple categories and for each category of intentions to be associated with a workflow. Based on current attachments and general context each Category team will receive and assist in the association of messages with certain function categories and tasks. This includes scanning existing anonymized communications and classifying them by their attachments. For example, if an email has a spreadsheet attachment, it can be sent to teams whose assigned category relates to spreadsheets. Individual messages could be sent to multiple teams if the category of those teams has interest in one or more of those attachments. This assignment work will be performed automatically.

The baseline dataset 150 is further formed by receiving messages along with the attached document by reviewing each message and highlighting the sections of the email that explicitly or implicitly relate to the attachment and highlighted sections of the text in the message and designate it as attribute and select the task from their list of assigned tasks. Every selection of text and task will be added to the baseline dataset 150.

Also, Category teams will review the full set of messages and intuitively deter nine which portions of the message relate to a service of their judgement item from the list in their assigned Category even when no attachments exists.

In other words, multiple teams scan through existing documents and texts and create the baseline dataset 150 to be input into the cognitive intention detection system 100 as an initial workflow determination.

Upon the first operation of the cognitive intention detection system 100, the user inputs a user input 160 into the cognitive intention detection system 100. Although the examples referred to herein are text inputs, the user input 160 can include any form of input, including but not limited to, text, voice, images, finger prints, retina detection, any biometric data, etc.

The transformation device 101 receives the user input 160 and the “stop words auxiliary verbs” are stripped out, the transformation process will stem the remaining words, and the top synonyms of the remaining words will be added to each tuple.

For example, if the user input 160 is a statement that “I would like to graphically illustrate the impact of this study”, the transformation device 101 strips out the auxiliary verbs and transforms the data to yield, for example, “graphically, illustrate, impact study”; “graphically, illustrate”.

Next, the transformation device 101 stems the data to yield, for example, “graphic, illustrate, impact study”.

Then, the transformation device 101 adds the top synonyms of the remaining words to the data to yield, for example, “graphic, visual, clear, illustrate, show, explain, clarify, Impact, effect, power, significant, Study, investigate, review, survey”.

The intention recognition device 102 receives output of the transformation device 101 and determines one or more options for automated workflow based on a learned association with the user input 160 in relationship to the baseline dataset 150 and the output of the transformation device 101.

For example, the intention recognition device 102 determines that a workflow of “formatting/inserting tables”, “formatting/inserting a chart”, and “support functions/spreadsheet” can be associated with the received data of “Graphic, visual, clear, illustrate, show, explain, clarify, impact, effect, power, significant, Study, investigate, review, survey”. That is, formatting or support functions are the category of a workflow to be used and the specific workflow associated with each can be inserting tables, inserting a chart, or creating a spreadsheet.

The display device 103 receives the workflow options from the intention recognition device 102 and the user is presented with one or more of the system's top guesses of his/her intended tasks (i.e., workflow to be used). The display device 103 can display the one or more of the system's top guesses, for example, in a side panel of a stationary list or a “floating list”. A “floating list” is a list of the system's top guesses that dynamically moves on a screen. However, any type of display can be used such that the user can visually see the choices of workflows. The side panel can be semi-transparent such that it does not interrupt the user's current work.

Even further, in the list displayed by the display device 103, when a user “hovers over” (i.e., uses a mouse, keeping a cursor on it, gazing at it, other selecting devices that are over the top of an item on the list) an option, the display device 103 presents the user with a description of the task functionality, templates available and other task related information. That is, wherein a user hovers over an option, the option is previewed via a text description.

Based on the list displayed by the display device 103, the user can select or not select a workflow/task to be performed using the selection device 104. The selection device 104 can include any known method of selecting an option from a graphical list.

If the user selects a workflow from the list, them the workflow automation device 105 provides functionality to complete the new task on hand. For example, if the user selects “formatting/inserting tables” from the list, the workflow automation device 105 will insert a table for the user.

All users' selections, such as task selection or list items dismissal, are input to the training device 106. The training device 106 continuously retrains the baseline dataset 150 based on the specific user selections to continuously enhance and better train the cognitive intention detection system 100 according to a specific user's needs.

That is, the cognitive intention detection system 100 begins with an initial input of a baseline dataset 150 to compare to a user input 160. However, after multiple user inputs and selections (or not selecting a workflow) using the selection device 104, the training device 106 updates the baseline dataset 150 to better provide the specific user with options more likely to be chosen by the specific user.

For example, if the user input 160 is transformed by the transformation device 101 to “Graphic, visual, clear, illustrate, show, explain, clarify, impact, effect, power, significant, Study, investigate, review, survey” and the user always selects “formatting/inserting a chart”, then the training device 106 will train the cognitive detection system 100 such that the display device 103 displays “formatting/inserting a chart” first on the list (i.e., the highest priority to be displayed on the list).

By the same training, if a user never selects “formatting/inserting tables”, “formatting/inserting tables” will be displayed last on the list (i.e., a lower priority on the list).

In other words, the merging of users' actions data by the selection device 104 to the semantic content and sequence of the users input 160 is continuously used by the training device 106 to further train the system for ever improving detection accuracy. Such training may be based on the frequency of the user selecting certain actions over time, but of course other mechanisms may be used additionally or alternatively, thereby to obtain optimal training of the device to each specific user.

User response(s) can be assimilated in the full body of machine learning corpus to continuously retrain the system by the training device 106 and enhance then strengthen the cognitive capabilities of associating text content and pattern to user intentions.

Such iterative training by the training device 106 expands the corpus of data used for the machine learning training database (i.e., the baseline data 150) and enables the system to recognize the needs and intentions of users with increasing success and confidence as user actions serve as feedback to expand the cognitive scope of knowledge of the system.

Also, the training device 106 can train the display device to display options that have previously not been selected to be lower on the list displayed by the display device 103 (i.e., have less of a priority of showing). For example, if a user always selects the same workflow, the training device 106 trains the display device 103 to display the workflow first on the list.

It should be noted that the intention recognition device 102 dynamically recognizes a workflow that the user may wish to use based on the continuous entering of more data with the user input 160.

For example, the intention recognition device 102 begins to determine an intention of the user based on, for example, a first word of the user input 160 and dynamically updates the determination of the user's intent as each new word is entered into the system.

For example, in an exemplary embodiment, a blogger is describing his findings or observations with respect to some quantitative information. As the blogger is composing his user input 160, the intention recognition device 102 will detect an intention on the part of the blogger to create a tabular representation of the information he is authoring and the display device 103 will display a list option to give the blogger the choice to present the data in a table form. If the blogger confirms his intention by the selection device 104, then the workflow automation device 105 will create a table template with the author's data.

Thus, any subsequent analysis will be performed using a machine learning algorithm such as SVM or Logistic Regression to rate every message based on all the total post process words score in relation to one Intention or another.

As words are typed or spoken the likelihood of various intentions is recomputed and normalized and then rated for probability with respect to various intentions. Ongoing use of the cognitive intention detection system 100 will continuously expand the training data set and future prediction will be statistically more reliable.

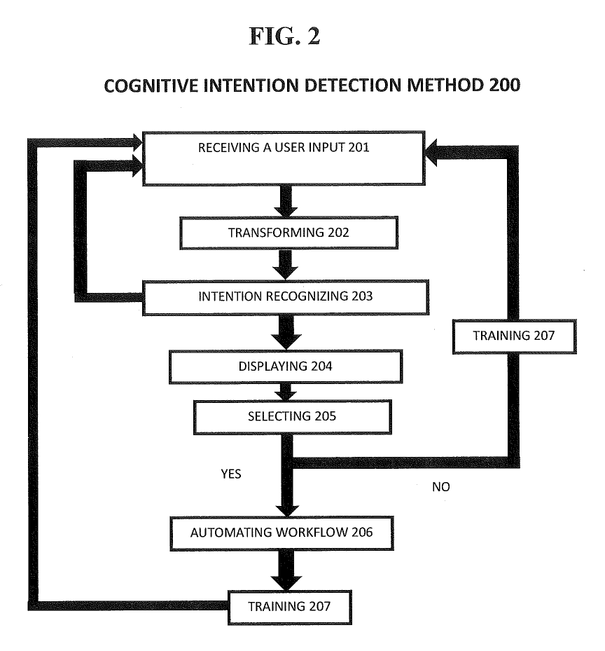

FIG. 2 shows a high level flow chart for a cognitive intention detection method 200 that includes a baseline dataset 150 created prior to the method by a team of users.

Step 201 receives a user input 160.

Step 202 receives the user input 160 and transforms the user input 160 by stripping out the stop words auxiliary verbs, stemming the remaining words, and adding the top synonyms of the remaining words to each tuple.

Step 203 receives the output data of the transformation device 101 and determines one or more options for automated workflow based on a learned association with the user input 160 in relationship to the baseline dataset 150 and the output data of the transforming 202.

If the user continues to update the user input 160, step 203 continues to update and determine a new intention of the user based on the updated user input 160.

Based on a determined intention of the user, step 204 displays the user with one or more of the system's top guesses of his/her intended tasks (i.e., workflow to be used). Step 204 can display the one or more of the system's top guesses, for example, in a side panel of a stationary list or floating list.

Based on the display list in step 204, step 205 allows the user to select a workflow from the display list. If the user selects a workflow (YES), then the cognitive intention detection method 200 proceeds to step 206 and automates the selected workflow.

If the user does not select a workflow from the display list (NO) in step 205, then the cognitive intention detection method 200 proceeds to step 207.

After automating the workflow 206, the process continues to step 207 for training. Thus, step 207 continuously trains the cognitive intention detection method 200 according to the user's selection (either (YES) or (NO) in step 205 so as to retrain the baseline dataset 150 based on the specific user selections to continuously enhance and better train the cognitive intention detection method 200 according to a specific user's needs.

In view of the foregoing and other problems, disadvantages, and drawbacks of the aforementioned conventional techniques, it is desirable to provide a new and improved cognitive intention detection system as described above which removes workflow from a user and offers to take some of the workflow or actions from the user and complete the workflow automatically based on a user input and the semantic meanings associated therewith.

Thus, the disclosed invention can provide a technical solution to the technical problem in the conventional approaches by setting up automated workflows (i.e., making a vote through e-mail, managing replies, building a chart, etc.) by the system recognizing the intention of the user based on the semantic content of the user input 160 and automating the workflow of, for example, managing the replies of all the user's votes in order to remove some workload from a user. Further, the system provides suggestions (i.e., via the display device 103) such that the system can train itself (i.e., continuously update the system) based on the history of a specific user to better offload tasks of the user in future user inputs. Accordingly, the system reduces the time to complete tasks, reduces costs to complete tasks, and reduces overall fatigue of a user.

### Exemplary Hardware Aspects, Using a Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

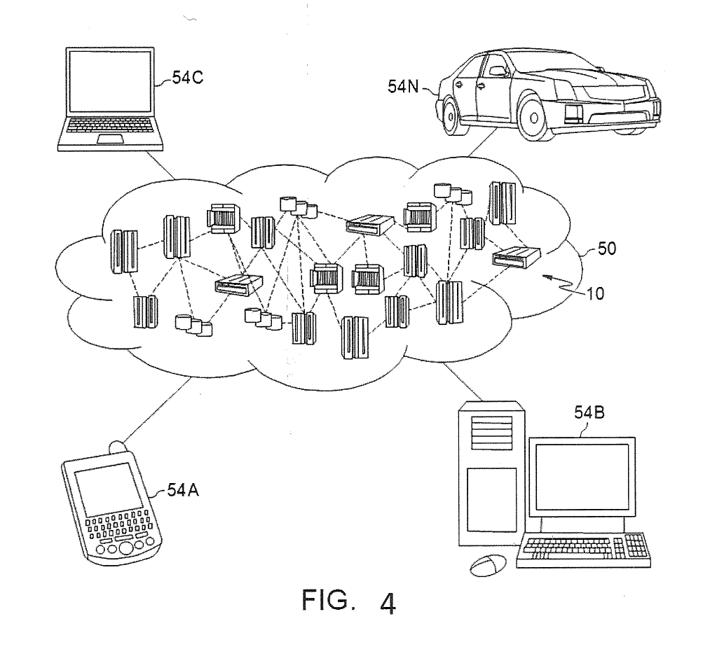

Referring now to FIG. 4, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the cognitive intention detection system 100 described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A cognitive intention detection method, comprising:
displaying one or more options for automated workflow based on a learned association with a user input;
selecting an option of the one or more options for automated workflow; and
automating a workflow based on the option selected in the selecting.

2. The method of claim 1, wherein the displaying is based on the learned association with the user input in relationship to a baseline dataset.

3. The method of claim 2, wherein the baseline dataset comprises a list of available functions categorized into a plurality of categories such that each category of the plurality of categories includes the learned association with the user input and is associated with a specific workflow.

4. The method of claim 1, further comprising transforming the user input by:
stripping out stop words auxiliary verbs;
stemming the words after the stripping; and
adding synonyms of remaining words to the user input.

5. The method of claim 1, further comprising, prior to the displaying, dynamically determining the one or more options for automated workflow based on the learned association with the user input.

6. The method of claim 1, further comprising:
after the selecting, training the learned association with the user input based on the option selected in the selecting.

7. The method of claim 1, further comprising:
after the selecting, training the learned association with the user input based on the option not selected in the selecting.

8. The method of claim 1, further comprising, if a second option of the one or more options is not selected, training the displaying to display the second option below the option of the one or more options for automated workflow.

9. The method of claim 2, further comprising, after the selecting, training the baseline dataset to determine an updated list of the one or more options such that the displaying displays the updated one or more options for automated workflow according to user action data in the selecting.

10. The method of claim 1, wherein the displaying displays the one or more options in a side panel.

11. The method of claim 1, wherein the one or more options for automated workflow displayed in the displaying is dynamically updated based on a change in the user input.

12. The method of claim 1, further comprising, during the selecting, previewing the one or more options selected via a text description.

13. The method of claim 1, further comprising determining an intention of the user input according to a semantic content and a sequence of items within the user input.

14. The method of claim 1, wherein the one or more options for automated workflow are displayed by the displaying so as to be semi-transparent.

15. The method of claim 1, further comprising determining the one or more options to be displayed by the displaying based on the learned association with the user input in relationship to a baseline dataset.

16. A non-transitory computer-readable recording medium recording a cognitive intention detection program, the program causing a computer to perform:
displaying one or more options for automated workflow based on a learned association with a user input;
selecting an option of the one or more options for automated workflow; and
automating a workflow based on the option selected in the selecting.

17. The non-transitory computer-readable recording medium of claim 16, wherein the displaying is based on the learned association with the user input in relationship to a baseline dataset.

18. The non-transitory computer-readable recording medium of claim 17, wherein the baseline dataset comprises a list of available functions categorized into a plurality of categories such that each category of the plurality of categories includes the learned association with the user input and is associated with a specific workflow.

19. The non-transitory computer-readable recording medium of claim 16, further comprising determining the one or more options to be displayed by the displaying based on the learned association with the user input in relationship to a baseline dataset.

20. A system for cognitive intention detection, comprising
a display device configured to display one or more options for automated workflow based on a learned association with a user input;
a selection device configured to select an option of the one or more options for automated workflow; and
a workflow automation device configured to automate a workflow based on the option selected by the selection device.
